(19) United States
(12) Patent Application Publication
(10) Pub. No.: US 2013/0170387 A1
(43) Pub. Date: Jul. 4, 2013

(54) Interference Measurement and Reporting for Device-to-Device Communications in a Communication System

(71) Applicants: Haiming Wang, Beijing (CN); Chunyan Gao, Beijing (CN)

(72) Inventors: Haiming Wang, Beijing (CN); Chunyan Gao, Beijing (CN)

(73) Assignee: NOKIA CORPORATION, Espoo (FI)

(21) Appl. No.: 13/821,178

(22) PCT Filed: Sep. 14, 2010
(86) PCT No.: PCT/CN10/76876

§ 371 Date: Mar. 6, 2013

(51) Int. Cl. H04W 24/02

(52) U.S. Cl. CPC H04W 24/02
USPC 370/252

(57) ABSTRACT

An apparatus, method and system for measuring interference for direct device-to-device communications in a communication system. In one embodiment, an apparatus includes a processor and memory including computer program code. The memory and the computer program code are configured, with the processor, to cause the apparatus to monitor an interference transmission from device-to-device (D2D) user equipment participating in cellular communications employing a communication resource; and format a message for reporting the interference levels observed during the interference transmission. In another embodiment, a memory and the computer program code are configured, with the processor, to cause the apparatus to monitor a precoded RS interference transmission from a node B station participating in cellular communications including D2D devices employing a communication resource; and format a message for reporting the RS levels observed during the interference transmission.

### TECHNICAL FIELD

The present invention is directed, in general, to communication systems and, in particular, to an apparatus, method and system to provide interference measurements and reporting for direct device-to-device communications in a communication system.

### BACKGROUND

Communications standards referred to as the long term evolution (“LTE”) of the Third Generation Partnership Project (“3GPP”), also referred to as 3GPP LTE, refers to research and development involving the 3GPP LTE Release 8 and beyond, which is the name generally used to describe an ongoing effort across the industry aimed at identifying technologies and capabilities that can improve systems such as the universal mobile telecommunication system (“UMTS”). The notation “LTE-A” is generally used in the industry to refer to further advancements in LTE. The goals of this broadly based project include improving communication efficiency, lowering costs, improving services, making use of new spectrum opportunities, and achieving better integration with other open standards.

The evolved universal terrestrial radio access network (“E-UTRAN”) in 3GPP includes base stations providing user plane (including packet data convergence protocol/radio link control/media access control/physical (“PDCP/RLC/MAC/PHY”) sublayers) and control plane (including a radio resource control (“RRC”) sublayer) protocol terminations towards wireless communication devices such as cellular telephones. A wireless communication device or terminal is generally known as user equipment (also referred to as “UE”). A base station is an entity of a communication network often referred to as a Node B or an NB. Particularly in the E-UTRAN, an “evolved” base station is referred to as an eNodeB or an eNB. For details about the overall architecture of the E-UTRAN, see 3GPP Technical Specification (“TS”) 36.300 v8.7.0 (2008-12), which is incorporated herein by reference. For details of the radio resource control management, see 3GPP TS 25.331 v.9.1.0 (2009-12) and 3GPP TS 36.331 v.9.1.0 (2009-12), which are incorporated herein by reference.

As wireless communication systems such as cellular telephone, satellite, and microwave communication systems become widely deployed and continue to attract a growing number of users, there is a pressing need to accommodate a large and variable number of communication devices that transmit an increasing quantity of data within a fixed spectral allocation and utilizing limited transmit power. The increased quantity of data is a consequence of wireless communication devices transmitting increasingly data centric information including video information, Internet based information which incorporates advanced graphics, exchanging data information which may incorporate graphical presentations, as well as performing ordinary voice communications. Such processes must be performed while accommodating substantially simultaneous operation of a large number of wireless communication devices using the same spectrum resources.

Cellular communication systems have typically been structured with an architecture that enables a UE to communicate with another UE equipment through one or more intermediary base stations that establish and control communication paths between the user equipment. However, direct communications between devices such as device-to-device (“D2D”), mobile-to-mobile (“M2M”), terminal-to-terminal (“T2T”), peer-to-peer (“P2P”) communications is beginning to be broadly integrated into cellular communication systems such as an LTE/LTE-A cellular communication system as specified in the 3GPP. Integration of direct D2D communications enable the end devices including user equipment such as mobile devices, terminals, peers, or machines to communicate over a direct wireless communication link that uses radio resources of the cellular communication system or network. In this manner, cellular communication resources are shared by the devices communicating directly with each other with other devices having a normal communication link to a base station.

Adding direct device-to-device communications into a cellular communication system enable the possibility to reduce transmitter power consumption, both in user equipment and in base stations, thereby increasing cellular communication system capacity and establishing more services for the user equipment. In an integrated communication system, communication resources are allocated to user equipment operating in the spectrum of the cellular communication system either in a cellular communication mode or in a semi-autonomous D2D communication mode. The use of D2D communication between a pair of devices, for example a pair of UEs, can reduce the use of resources required for communication as the need for resources between the NB and the devices is significantly reduced. Moreover, even though the D2D communication also occupies cellular resources, the interference generated by the D2D communications between closely positioned UEs may be quite low to other UEs that are farther away, due to the low transmission power needed, thus the communications resource may be shared and effectively increase the efficiency of the system.

In order to share the communications resource, coordination is required between the D2D devices and the controlling cellular NB. The coordination is based on the measurement of interference and reports from the D2D devices and or cellular UEs in the area serviced by a NB station. Thus efficient methods and apparatus for measuring and reporting interference due to the use of D2D communications in a shared resource are needed. The methods and apparatus should have low implementation complexity and incur low costs on both cellular and D2D UEs.

### SUMMARY OF THE INVENTION

These and other problems are generally solved or circumvented, and technical advantages are generally achieved, by embodiments of the present invention, which include an apparatus, method and system to receive a downlink (DL) resource allocation reserving a portion of a symbol for a device-to-device (D2D) preamble transmission; monitor an interference transmission from D2D user equipment participating in cellular communications employing a communication resource; and format a message for reporting the interference levels observed during the interference transmission.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the invention, and the advantages thereof, reference is now made to the following descriptions taken in conjunction with the accompanying drawings, in which:

FIGS. 1 and 2 illustrate system level diagrams of embodiments of communication systems including a base station and wireless communication devices that provide an environment for application of the principles of the present invention;

FIGS. 3 and 4 illustrate system level diagrams of embodiments of communication systems including wireless communication systems that provide an environment for application of the principles of the present invention;

FIG. 5 illustrates a system level diagram of an embodiment of a communication element of a communication system for application of the principles of the present invention;

FIG. 6 illustrates a system level diagram of an embodiment of a communication system demonstrating exemplary interference associated with wireless communication devices in accordance with the principles of the present invention;

FIG. 7 illustrates a frame configuration for use in wireless communications devices and with embodiments of the invention;

FIG. 8 illustrates predefined subframe configurations for TDD communications for use with embodiments of the invention;

FIG. 9 illustrates a frame configuration resulting from the use of a method embodiment of the present invention;

FIG. 10 illustrates a frame configuration resulting from the use of an alternative method embodiment of the present invention;

FIG. 11 illustrates a frame configuration resulting from the use of an alternative method embodiment of the present invention;

FIG. 12 illustrates a frame configuration resulting from the use of an alternative method embodiment of the present invention; and

FIG. 13 illustrates a frame configuration resulting from the use of yet another alternative method embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. In view of the foregoing, the present invention will be described with respect to exemplary embodiments in a specific context of an apparatus, method and system to efficiently enable making interference measurements and measurement reporting for D2D communications that employs spectrum of a cellular communication system, so that interference may be managed between the two communications modes. The apparatus, methods and system are applicable, without limitation, to any communication system including existing and future 3 GPP technologies such as UMTS, LTE, and its future variants such as 4th generation (“4G”) communication systems.

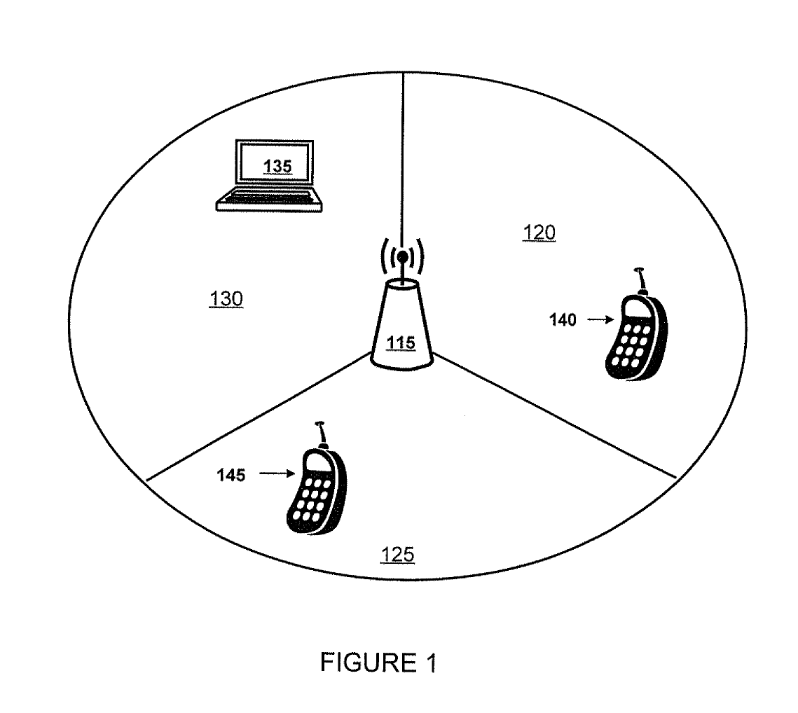

Turning now to FIG. 1, illustrated is a system level diagram of an embodiment of a communication system including a base station 115 and wireless communication devices (e.g., user equipment) 135, 140, 145 that provides an environment for application of the principles of the present invention. The base station 115 is coupled to a public switched telephone network (not shown). The base station 115 is configured with a plurality of antennas to transmit and receive signals in a plurality of sectors including a first sector 120, a second sector 125, and a third sector 130, each of which typically spans 120 degrees. The three sectors or more than three sectors are configured per frequency, and one base station 115 can support more than one frequency. Although FIG. 1 illustrates one wireless communication device (e.g., wireless communication device 140) in each sector (e.g. the first sector 120), a sector (e.g. the first sector 120) may generally contain a plurality of wireless communication devices. In an alternative embodiment, a base station 115 may be formed with only one sector (e.g. the first sector 120), and multiple base stations may be constructed to transmit according to co-operative multi-input/multi-output (“C-MIMO”) operation, etc.

The sectors (e.g. the first sector 120) are formed by focusing and phasing radiated signals from the base station antennas, and separate antennas may be employed per sector (e.g. the first sector 120). The plurality of sectors 120, 125, 130 increases the number of subscriber stations (e.g., the wireless communication devices 135, 140, 145) that can simultaneously communicate with the base station 115 without the need to increase the utilized bandwidth by reduction of interference that results from focusing and phasing base station antennas. While the wireless communication devices 135, 140, 145 are part of a primary communication system, the wireless communication devices 135, 140, 145 and other devices such as machines (not shown) may be a part of a secondary communication system to participate in, without limitation, D2D and machine-to-machine communications or other communications.

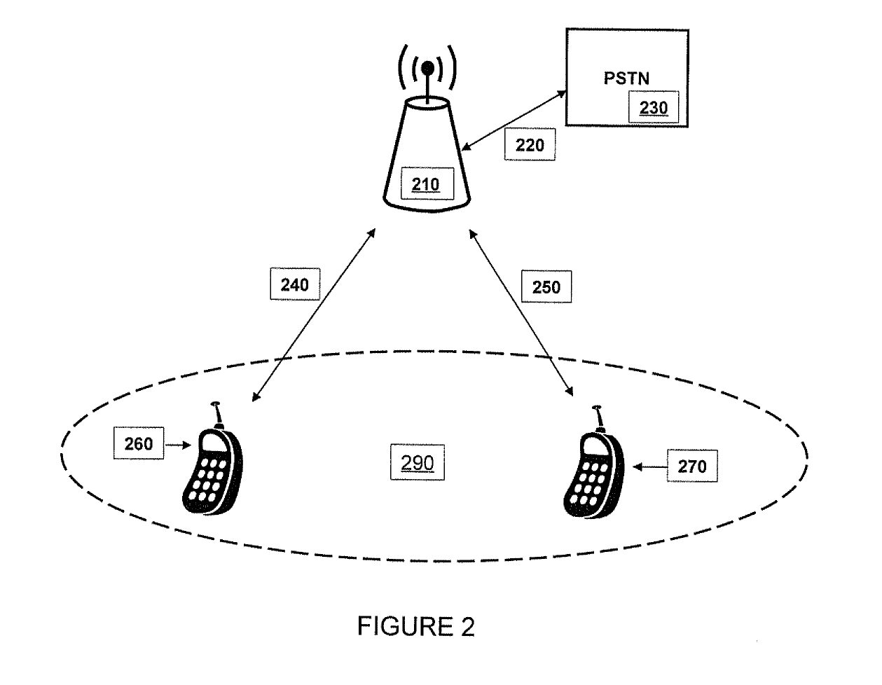

Turning now to FIG. 2, illustrated is a system level diagram of an embodiment of a communication system including a base station 210 and wireless communication devices (e.g., user equipment) 260, 270 that provides an environment for application of the principles of the present invention. The communication system includes the base station 210 coupled by communication path or link 220 (e.g., by a fiber-optic communication path) to a core telecommunications network such as public switched telephone network (“PSTN”) 230. The base station 210 is coupled by wireless communication paths or links 240, 250 to the wireless communication devices 260, 270, respectively, that lie within its cellular area 290.

In operation of the communication system illustrated in FIG. 2, the base station 210 communicates with each wireless communication device 260, 270 through control and data communication resources allocated by the base station 210 over the communication paths 240, 250, respectively. The control and data communication resources may include frequency and time-slot communication resources in frequency division duplex (“FDD”) and/or time division duplex (“TDD”) communication modes. While the wireless communication devices 260, 270 are part of a primary communication system, the wireless communication devices 260, 270 and other devices such as machines (not shown) may be a part of a secondary communication system to participate in, without limitation, device-to-device and machine-to-machine communications or other communications.

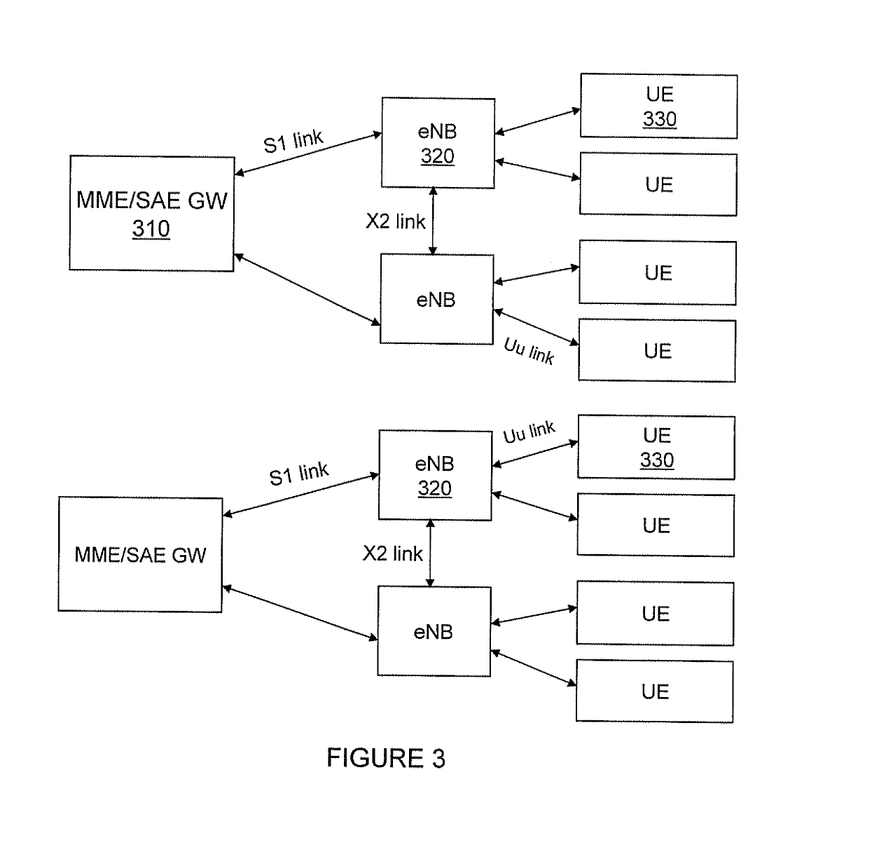

Turning now to FIG. 3, illustrated is a system level diagram of an embodiment of a communication system including a wireless communication system that provides an environment for the application of the principles of the present invention. The wireless communication system may be configured to provide evolved UMTS terrestrial radio access network (“E-UTRAN”) universal mobile telecommunications services. A mobile management entity/system architecture evolution gateway (“MME/SAE GW,” one of which is designated 310) provides control functionality for an E-UTRAN node B (designated “eNB,” an “evolved node B,” also referred to as a “base station,” one of which is designated 320) via an S1 communication link (ones of which are designated “S1 link”). The base stations 320 communicate via X2 communication links (ones of which are designated “X2 link”). The various communication links are typically fiber, microwave, or other high-frequency communication paths such as coaxial links, or combinations thereof.

The base stations 320 communicate with wireless communication devices such as user equipment (“UE,” ones of which are designated 330), which is typically a mobile transceiver carried by a user. Thus, the communication links (designated “Uu” communication links, ones of which are designated “Uu link”) coupling the base stations 320 to the user equipment 330 are air links employing a wireless communication signal such as, for example, an orthogonal frequency division multiplex (“OFDM”) signal. While the user equipment 330 are part of a primary communication system, the user equipment 330 and other devices such as machines (not shown) may be a part of a secondary communication system to participate in, without limitation, D2D and machine-to-machine communications or other communications.

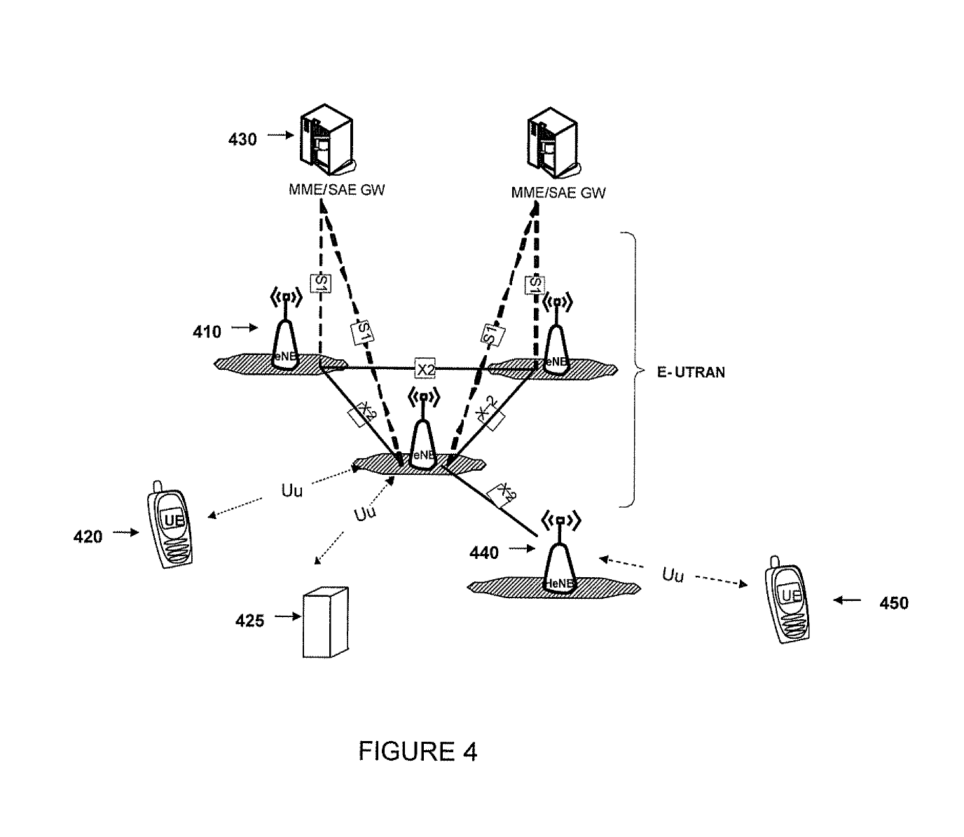

Turning now to FIG. 4, illustrated is a system level diagram of an embodiment of a communication system including a wireless communication system that provides an environment for the application of the principles of the present invention. The wireless communication system provides an E-UTRAN architecture including base stations (one of which is designated 410) providing E-UTRAN user plane (packet data convergence protocol/radio link control/media access control/physical) and control plane (radio resource control) protocol terminations towards wireless communication devices such as user equipment 420 and other devices such as machines 425 (e.g., an appliance, television, meter, etc.). The base stations 410 are interconnected with X2 interfaces or communication links (designated “X2”). The base stations 410 are also connected by S1 interfaces or communication links (designated “S1”) to an evolved packet core (“EPC”) including a mobile management entity/system architecture evolution gateway (“MME/SAE GW,” one of which is designated 430). The S1 interface supports a multiple entity relationship between the mobile management entity/system architecture evolution gateway 430 and the base stations 410. For applications supporting inter-public land mobile handover, inter-eNB active mode mobility is supported by the mobile management entity/system architecture evolution gateway 430 relocation via the S1 interface.

The base stations 410 may host functions such as radio resource management. For instance, the base stations 410 may perform functions such as internet protocol (“IP”) header compression and encryption of user data streams, ciphering of user data streams, radio bearer control, radio admission control, connection mobility control, dynamic allocation of communication resources to user equipment in both the uplink and the downlink, selection of a mobility management entity at the user equipment attachment, routing of user plane data towards the user plane entity, scheduling and transmission of paging messages (originated from the mobility management entity), scheduling and transmission of broadcast information (originated from the mobility management entity or operations and maintenance), and measurement and reporting configuration for mobility and scheduling. The mobile management entity/system architecture evolution gateway 430 may host functions such as distribution of paging messages to the base stations 410, security control, termination of user plane packets for paging reasons, switching of user plane for support of the user equipment mobility, idle state mobility control, and system architecture evolution bearer control. The user equipment 420 and machines 425 receive an allocation of a group of information blocks from the base stations 410.

Additionally, the ones of the base stations 410 are coupled a home base station 440 (a device), which is coupled to devices such as user equipment 450 and/or machines (not shown) for a secondary communication system. The base station 410 can allocate secondary communication system resources directly to the user equipment 450 and machines, or to the home base station 440 for communications (e.g., local or D2D communications) within the secondary communication system. The secondary communication resources can overlap with communication resources employed by the base station 410 to communicate with the user equipment 420 within its serving area. For a better understanding of home base stations (designated “HeNB”), see 3 GPP TS 32.781 v.9.1.0 (2010-03), which is incorporated herein by reference. While the user equipment 420 and machines 425 are part of a primary communication system, the user equipment 420, machines 425 and home base station 440 (communicating with other user equipment 450 and machines (not shown)) may be a part of a secondary communication system to participate in, without limitation, D2D and machine-to-machine communications or other communications.

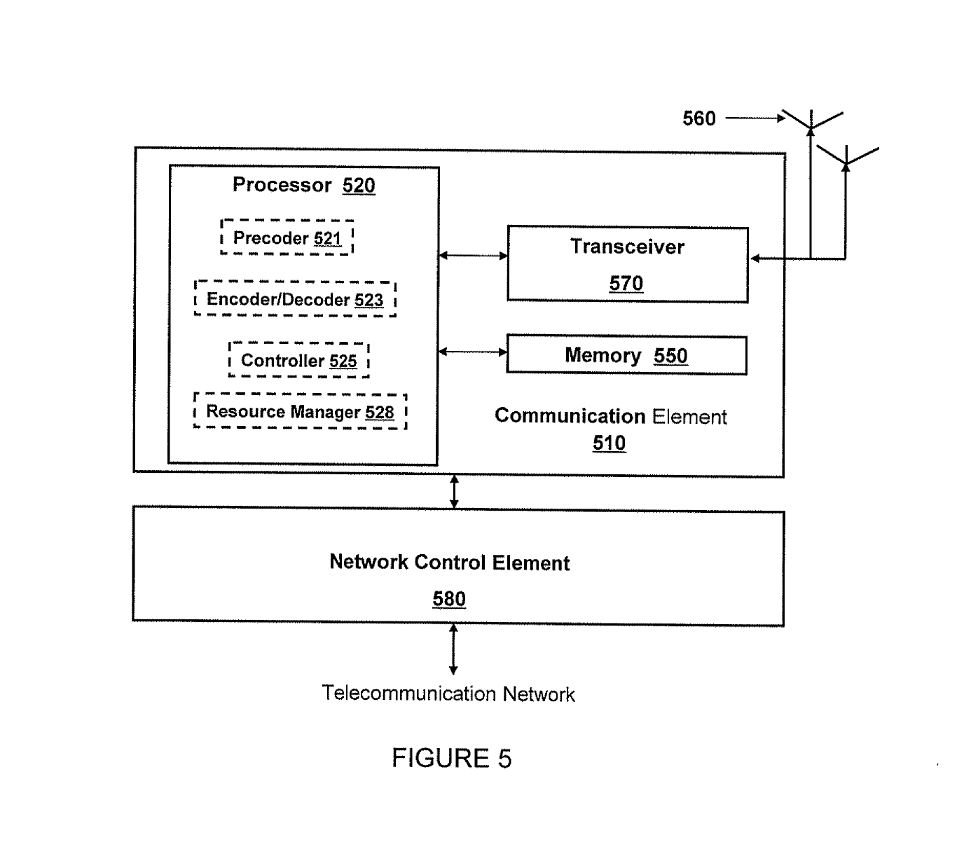

Turning now to FIG. 5, illustrated is a system level diagram of an embodiment of a communication element 510 of a communication system for application of the principles of the present invention. The communication element or device 510 may represent, without limitation, a base station, a wireless communication device (e.g., a subscriber station, terminal, mobile station, user equipment, machine), a network control element, a communication node, or the like. When the communication element or device 510 represents a user equipment, the user equipment may be configured to communicate with another user equipment employing one or more base stations as intermediaries in the communication path (referred to as cellular communications). The user equipment may also be configured to communicate directly with another user equipment without direct intervention of the base station in the communication path (referred to as device-to-device (“D2D”) communications). The communication element 510 includes, at least, a processor 520, memory 550 that stores programs and data of a temporary or more permanent nature, an antenna 560, and a radio frequency transceiver 570 coupled to the antenna 560 and the processor 520 for bidirectional wireless communications. The communication element 510 may be formed with a plurality of antennas to enable a multiple-input multiple output (“MIMO”) mode of operation. The communication element 510 may provide point-to-point and/or point-to-multipoint communication services.

The communication element 510, such as a base station in a cellular communication system or network, may be coupled to a communication network element, such as a network control element 580 of a public switched telecommunication network (“PSTN”). The network control element 580 may, in turn, be formed with a processor, memory, and other electronic elements (not shown). The network control element 580 generally provides access to a telecommunication network such as a PSTN. Access may be provided using fiber optic, coaxial, twisted pair, microwave communications, or similar link coupled to an appropriate link-terminating element. A communication element 510 formed as a wireless communication device is generally a self-contained device intended to be carried by an end user.

The processor 520 in the communication element 510, which may be implemented with one or a plurality of processing devices, performs functions associated with its operation including, without limitation, precoding of antenna gain/phase parameters (precoder 521), encoding and decoding (encoder/decoder 523) of individual bits forming a communication message, formatting of information, and overall control (controller 525) of the communication element, including processes related to management of communication resources (resource manager 528). Exemplary functions related to management of communication resources include, without limitation, hardware installation, traffic management, performance data analysis, tracking of end users and equipment, configuration management, end user administration, management of wireless communication devices, management of tariffs, subscriptions, security, billing and the like. For instance, in accordance with the memory 550, the resource manager 528 is configured to allocate primary and second communication resources (e.g., time and frequency communication resources) for transmission of voice communications and data to/from the communication element 510 and to format messages including the communication resources therefore in a primary and secondary communication system.

The execution of all or portions of particular functions or processes related to management of communication resources may be performed in equipment separate from and/or coupled to the communication element 510, with the results of such functions or processes communicated for execution to the communication element 510. The processor 520 of the communication element 510 may be of any type suitable to the local application environment, and may include one or more of general-purpose computers, special purpose computers, microprocessors, digital signal processors (“DSPs”), field-programmable gate arrays (“FPGAs”), application-specific integrated circuits (“ASICs”), and processors based on a multi-core processor architecture, as non-limiting examples.

The transceiver 570 of the communication element 510 modulates information on to a carrier waveform for transmission by the communication element 510 via the antenna(s) 560 to another communication element. The transceiver 570 demodulates information received via the antenna(s) 560 for further processing by other communication elements. The transceiver 570 is capable of supporting duplex operation for the communication element 510.

The memory 550 of the communication element 510, as introduced above, may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. The programs stored in the memory 550 may include program instructions or computer program code that, when executed by an associated processor, enable the communication element 510 to perform tasks as described herein. Of course, the memory 550 may form a data buffer for data transmitted to and from the communication element 510. Exemplary embodiments of the system, subsystems, and modules as described herein may be implemented, at least in part, by computer software executable by processors of, for instance, the wireless communication device and the base station, or by hardware, or by combinations thereof. As will become more apparent, systems, subsystems and modules may be embodied in the communication element 510 as illustrated and described herein.

Efficiency in the utilization of communication resources can be obtained by structuring cellular communication systems with an architecture that enables direct device-to-device, mobile-to-mobile, terminal-to-terminal, and peer-to-peer communications is beginning to be broadly integrated into cellular communication systems such as an LTE/LTE-A cellular communication systems as specified in 3GPP. The D2D communications enable the user equipment such as mobile devices, terminals, peers, or machines to communicate over a wireless communication link that avoids using one or more base stations as intermediaries in the communication path. The D2D communications use radio communication resources of the cellular communication system or network, thus sharing cellular communication resources with devices having a normal communication link to a base station. An exemplary cellular communication system or network operates in frequency division duplex mode in which device-to-device connections utilize time division duplex mode using cellular communication system or network uplink (“UL”), downlink (“DL”), or combination thereof, communication resources controlled by the base station(s). The general concept of the FDD or TDD cellular communication systems wherein a direct communication connection utilizes either FDD or TDD communications are described in International Patent Application WO 2005/060182 by McLaughlin, et al., entitled “Cellular Communication System,” filed Dec. 16, 2004, which is incorporated herein by reference.

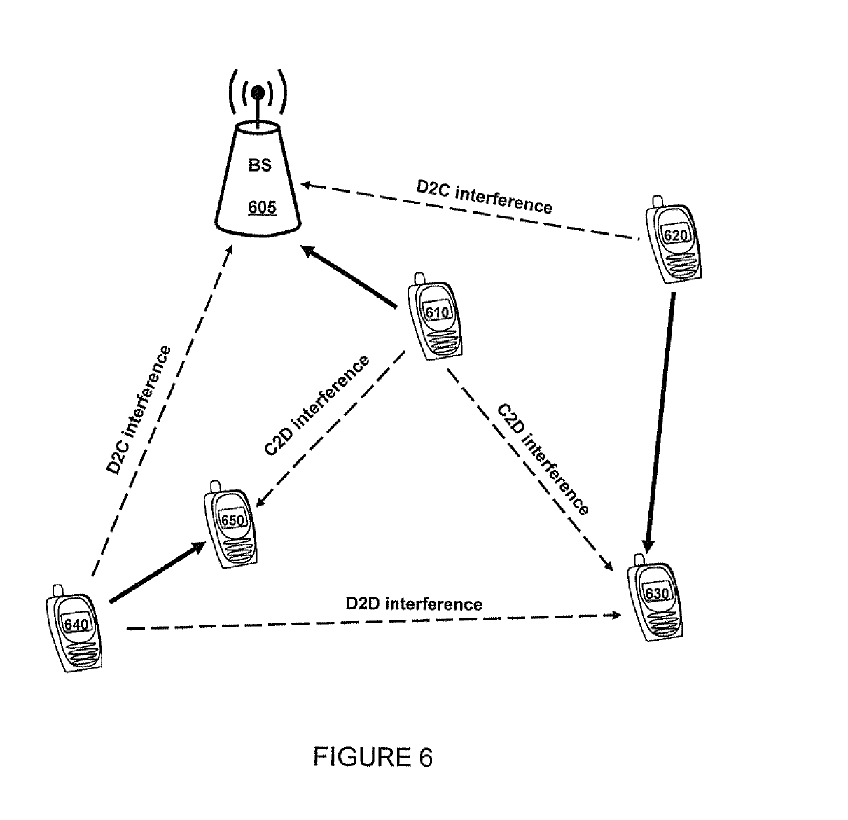

Turning now to FIG. 6, illustrated is a system level diagram of an embodiment of a communication system demonstrating exemplary interference associated with wireless communication devices (e.g., user equipment) in accordance with the principles of the present invention. The types of interference illustrated with respect to FIG. 6 occur as result of spectral reuse among user equipment for cellular communications and D2D communications in the communication system. The communication system includes a base station 605 and first, second, third, fourth and fifth user equipment 610, 620, 630, 640, 650 within a served area. The first user equipment 610 transmits a signal over an uplink to the base station 605. The second user equipment 620 transmits a signal over a direct device-to-device link to the third user equipment 630. The fourth user equipment 640 transmits a signal over a direct device-to-device link to the fifth user equipment 650.

One type of interference illustrated in FIG. 6 is cellular-to-device (“C2D”) interference, wherein cellular communications (or transmissions) interfere with D2D communications as represented as the C2D interference. Another type of interference is D2D interference, wherein D2D communications interfere with one another each other as represented as the D2D interference. A third type of interference is device-to-cellular (“D2C”) interference, wherein a D2D communication interferes with cellular communications as represented as the D2C interference.

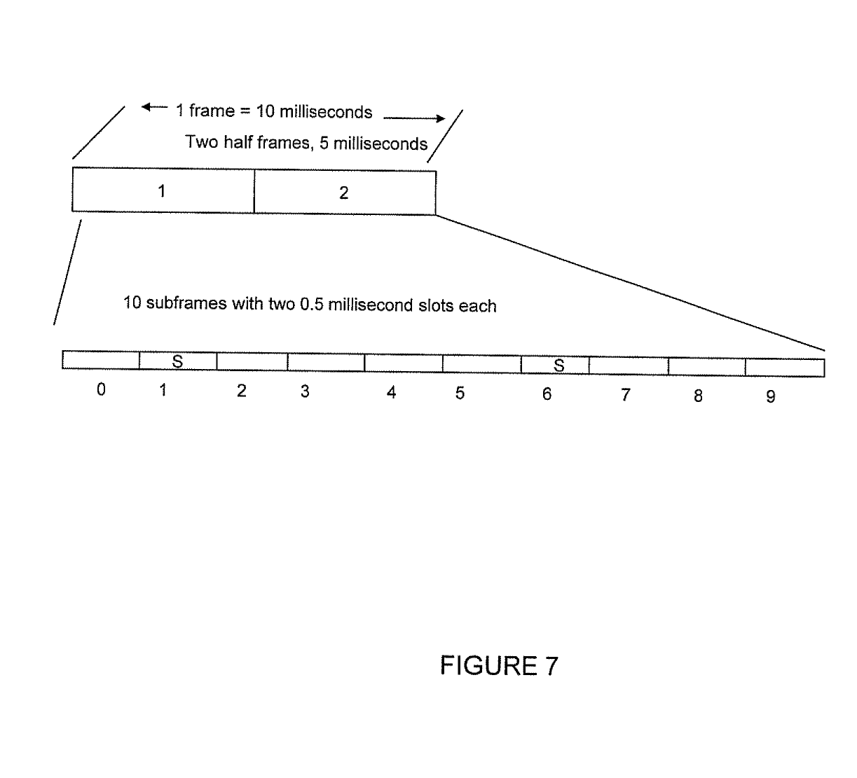

In FIG. 7, the typical LTE frame and subframe arrangements are depicted. An LTE frame is defined as a 10 milliseconds long frame divided into two half frames. Each half frame is thus 5 milliseconds in duration. The LTE frame is defined as having 10 subframes of 1 milliseconds duration each. These are also shown in FIG. 7. The subframes are numbered 0-9. In the example shown, two of these subframes are the special subframe labeled “S”. In some configurations that are heavily DL loaded, only one “S” subframe is used. The S subframe is between a DL subframe and a following UL subframe. The special TDD subframes “S” contain three portions of adjustable length, a Downlink Pilot Time Slot (DwPTS), and number of guard period symbols (GP), and an Uplink Pilot Time Slot (UpPTS).

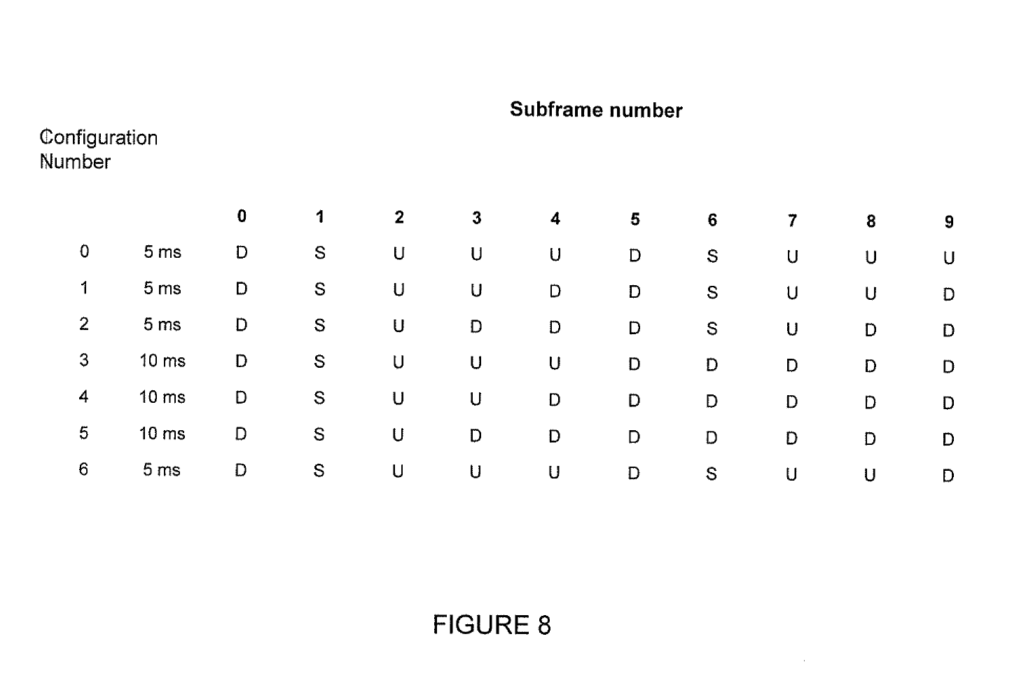

The LTE TDD specifications support dynamic resource allocation adjustment of downlink and uplink resources. This is performed by changing the TDD configuration to one of 7 predefined configurations. FIG. 8 depicts the seven predefined configurations. In FIG. 8, the subframes are labeled “D” for downlink resources, “U” for uplink resources and “S” for the special subframe. Also shown is the switching periodicity which is either 5, or 10, milliseconds, the period for switching from downlink to uplink communications. Some configurations are arranged for more downlink resources, for example configuration #5 is highly concentrated in downlink resources. For the configurations with 10 millisecond periodicity, only one S subframe may be used. These configuration support highly asymmetric communications, for example, internet browsing where a mobile device is receiving pages from an internet website, which is highly asymmetric traffic.

Certain TDD subframes are “S’ or special subframes. There is either one or two of these subframes in each frame, typically one for each of the half frames. This S subframe is used to ensure there is a guard period (GP) between downlink and uplink communications. In order to maintain flexibility, the time duration of the GP portions is adjustable. In the TDD configurations of FIG. 8 it can be observed that the uplink subframes U are always following a special S subframe, so that there is always a guard period GP to allow the TDD communications link to switch directions.

In order to effectively control the resource allocations and resource sharing to minimize interference that will occur when enabling D2D communications in a cellular system, a method and apparatus for measuring interference, and methods for reporting the interference measurements to a cell serving base station that controls the user equipment devices in a cell, are needed. To provide the interference information without adversely impacting the efficiency of the system, the methods should avoid using system resources that could be used for cellular communications, that is, the methods should avoid reducing the available resources.

For a system with D2D communications, there can be interference in the uplink or UL resources in the cellular network. This interference may be from cellular UE to D2D device users that are sharing the same resources. The UL interference may be measured by observations (measurements) made at the D2D devices, and the measurements could be made in the UL time slots and reported to the NB station.

As shown in FIG. 8, if a heavily downlink concentration configuration such as TDD configuration #5 is selected, then there are few UL resources available for D2D communications. Therefore, if these few UL resources were used for interference measurement and reporting functions this would further reduce the limited available UL resources.

In this scenario, it may be preferable or even made mandatory by the system requirements that D2D communications be performed within DL subframes. In this case, when the D2D devices are transmitting, interference may occur to the adjacent cellular UEs that are simultaneously receiving cellular messages (downlink messages from a node B, for example) This D2C interference level may be different from what the D2D devices measure in UL slots, due to different transmit power levels used by cellular UE and D2D devices. In this case a measurement of the interference in the DL resource made by the UE cellular devices would be more accurate.

Another source of interference that is to be considered when D2D devices are performed within DL subframes of cellular systems is the interference that may occur from the cellular NB stations to the D2D devices. This interference may be expected to be even more severe than the interference from D2D devices to cellular UEs, because an eNB or NB station has larger transmit power than a user equipment or other mobile device in the cellular system. Since the common reference signals (CRS) sent by the NB are sent at full bandwidth with fixed power, the measurement report from the D2D equipment on interference from the CRS transmission is not very helpful, because the transmit power is already fixed.

In addition, the accuracy of the measurement of interference in the DL subframes is made more complex by the fact that that during DL subframes, there is also transmission from both serving NBs and potentially from neighboring NBs. In this case the interference from the devices or NBs cannot be measured accurately. In order to ensure that the measurements of interference are made accurately, there should be some DL resources reserved to let cellular UEs measure the interference from D2D devices, or to let D2D devices measure interference from the serving NB. Also, in order to make these measurements accurate, there should be some coordination among NBs on the reserved DL resource for D2D or NB transmission. In other words, when the interference measurements are taking place, some coordination between neighboring base stations will ensure the measurements reflect only the interference being measured.

However, it is not desirable to arrange that the reserved DL resource for interference measurement occupy an entire DL subframe, as that approach would result in significant resource reduction for cellular transmission.

What is needed then are approaches that enable accurate measurement of interference from D2D to cellular UE, and from NB to D2D devices, and methods to report these. The method embodiments now described address these needs.

In one exemplary method embodiment, the DL resources are shared using spatial resource reuse. In this approach, the NB uses beamforming for cellular communications to UEs. Since the beamforming used by the NB is spatially directional, D2D devices not in the beam direction can then use the same DL resource, for providing D2D communications, and later reporting, in an efficient manner. Reporting interference measurements is an uplink message and so will be performed during an UL subframe.

In one method embodiment, the NB station first predefines some beamform weight matrixes, or predetermined precoding matrixes, with each matrix corresponding to one spatial/beamforming direction. The NB then transmits the precoded reference signals (RS) with each beamform or precoding matrix in predefined orthogonal resources. That is, RS precoded with each beamform or precoding matrix is code division multiplexed (CDM), frequency division multiplexed (FDM) or time division multiplexed (TDM). The beamforming or precoding matrix and the predefined or reserved resources are signaled to the D2D devices, for example via a broadcast message. The D2D devices then measure the interference and later report the measurements for each beamform or spatial direction; alternatively the D2D devices may report only the beam/spatial direction of the strongest (or weakest) interference. Then, based on the D2D measurement reports, the NB station allocates the resources that may be shared between the UE cellular and D2D devices. Devices that are within the beam during the NB RS transmission will measure the highest level of interference. Devices that are outside the direction of the beam will measure the lowest level of interference during the NB transmissions. When the NB receives the measurement reports from the devices, the decision to allocate D2D resources may be made allowing those devices away from the beam direction to share downlink resources, while those devices reporting high interference may not perform D2D communications in the same downlink resource allocations.

In addition, measurement and reporting are needed for interference from the D2D devices to the cellular UEs in downlink (DL) resources. This information will be used to further refine the NB determinations on shared resource allocation. In order to enable the measurements and reports to occur during DL subframes, some reservation of DL resources for D2D preamble transmission is also necessary,

In one embodiment, a method is provided to reserve resources for both of the above described interference measurements in which some OFDM symbols are reserved in the guard period (GP) of the special “S” subframe. The reserved symbols are used either for preamble transmission by D2D devices, or for the beamformed/precoding reference symbol (RS) transmission by the node B. In this embodiment, a guard period reservation is coordinated among neighboring NB or eNB stations. The reservation is to one or multiple OFDM symbols, and it does not reduce the available resources for normal transmission. In the guard period of the special subframe, there is no NB transmission when the GP is reserved for the D2D preamble, and similarly no D2D or other cells NB transmission when the GP is reserved for beamformed/precoded matrix RS transmissions by the NB. In this manner the interference measurements can be made even more accurate. This embodiment applies to the case of D2D deployments in TDD cellular systems. Since the D2D UEs are physically close to one another, a shorter guard period is needed for D2D communications, so it is feasible to “steal” some of the symbols from the allocated GP time for the interference measurement use.

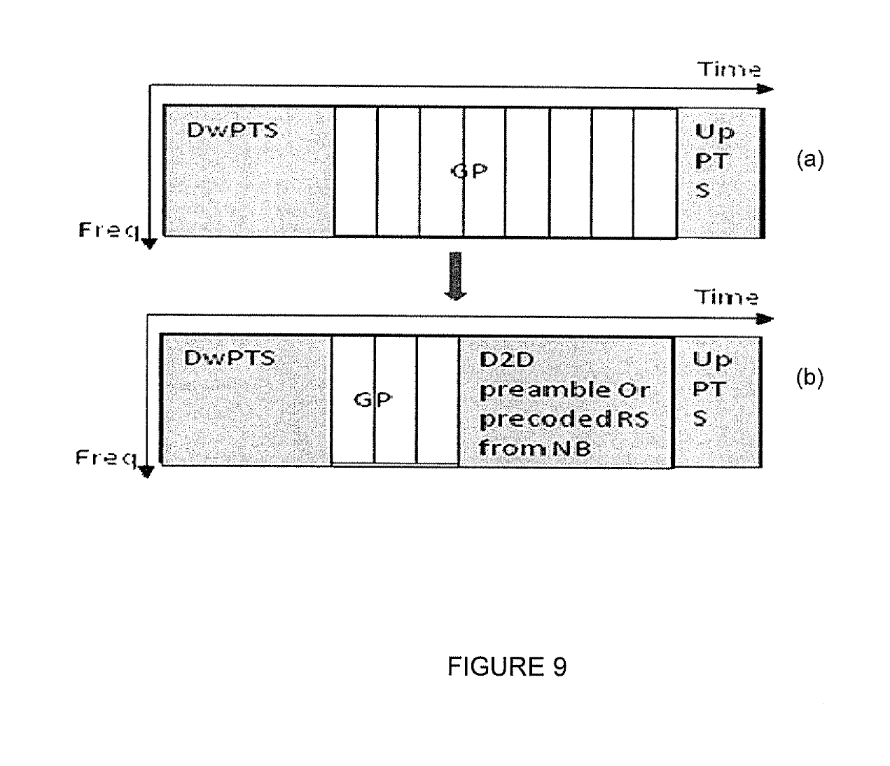

FIG. 9 illustrates the use of this method. The “S” subframe is shown with the DwPTS symbol followed by the guard period (GP). In the example labeled “a”, the existing special subframe S format is shown. In the example labeled “b”, the method embodiment is applied to the S subframe and additional D2D preamble, or RS signals from the NB, are shown using some of the symbols in the GP. The last portion of the special subframe is the UpPTS symbol in both examples “a” and “b” of FIG. 9.

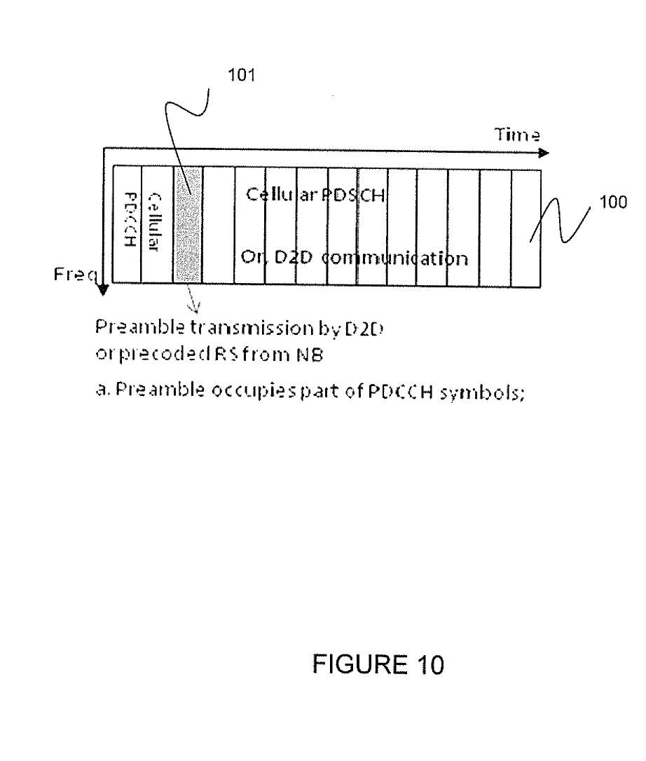

In another embodiment, a different approach is used. In this method, some control signaling symbols in one downlink (DL) subframe are reserved for D2D preamble or transmission, or, for NB beamform/precoded RS transmissions. For example, one DL channel is the physical downlink control channel. In cases where the node B does not transmit physical downlink control channel symbols (PDCCH), the D2D transmissions can occur. Examples of PDSCH sequences using this approach are shown in FIGS. 10-12. In this method embodiment, the reservation is restricted to be in some, or all, of the N control signaling symbols, where N is indicated by the physical control format information channel (PCFICH) or a value otherwise configured by the controlling node B. Other OFDM symbols in the same subframe are available for use for D2D communication, or for cellular PDSCH/PDCCH symbols. If the symbols are reserved for D2D preamble transmission, the preambles sent by the D2D UEs can be specially designed to make the measurement and interference reporting transparent to the cellular UEs. In this alternative embodiment, the preamble can be in the form of the PDCCH command. Those UEs that are close to the D2D UEs may successfully detect the PDCCH command and react to it. In this case, the Node B then knows that these reacting cellular UEs are physically close to the D2D transmitters. This method embodiment allows for efficient resource usage by limiting the preamble to several OFDM symbols, and other OFDM symbols may be utilized for D2D communication and/or cellular PDSCH/PDCCH. In this method, additional symbols such as semi persistent scheduling (SPS) or cross component carrier {“cross-cc”} scheduled PDSCH can be transmitted in the 14-N OFDM symbols if all control signaling symbols are occupied by preamble transmission. When using this method embodiment, the impact of the D2D method on the existing channel estimation scheme typically done in cellular PDSCH detection may be minimized by retaining the existing CRS in the first OFDM symbol set by the Node B, and the preamble sent by the D2D may then be used in other ones in the N control signaling symbols in the channel format.

FIG. 10 depicts a first PDCCH format for this method. In FIG. 10, a symbol or symbols 101 is reserved for either preamble transmission by the D2D devices, or for transmission of the precoded RS from the eNB or NB station. The remaining symbols in the PDCCH may be used for D2D data communication or for cellular communication such as physical downlink shared channel (PDSCH) symbols, as shown in the right hand (increasing time) portion of the frame/

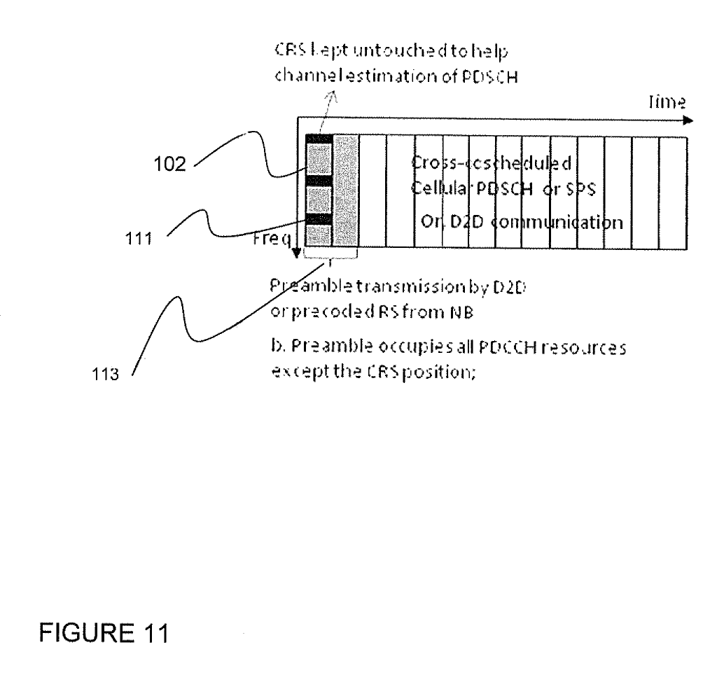

FIG. 11 depicts another frame format that may be used with this method. In FIG. 11, the preamble transmission may occur in a portion of the symbols 111, 113 as shown. However, the dark bands in the symbol 111 indicate that for that portion of the frequency spectrum, the common reference signals (CRS) that are provided in the PDCCH are kept. These signals assist with the signaling channel estimation and by preserving them as part of the PDCCH, the channel estimation scheme preserved. Again, the unused symbols in the PDCCH may be used for cellular message symbols or for D2D communication. For certain systems, semi-persistent scheduled (SPS) symbols may be communicated in the DL in the unused symbols. Cross-component carrier (cross-cc) signals may be communicated in the remaining symbols.

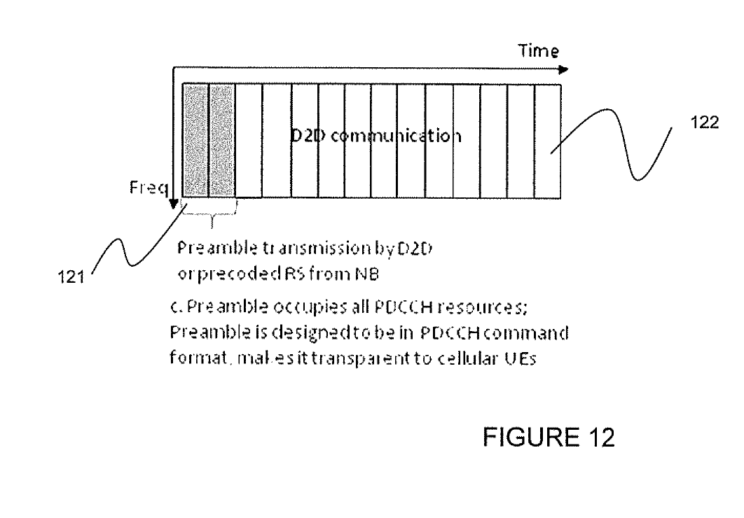

FIG. 12 depicts yet another frame format that may be used with this method embodiment. In FIG. 12, the PDCCH is completely occupied by the preamble transmission 121. The remaining symbols are used for D2D communication. By making the preamble in a PDCCH format, it is transparent to cellular UEs. Those UEs that are physically close to the D2D devices may react to the message, and by detecting these UE responses, the node B can identify those devices which are likely to be affected by the D2D communications.

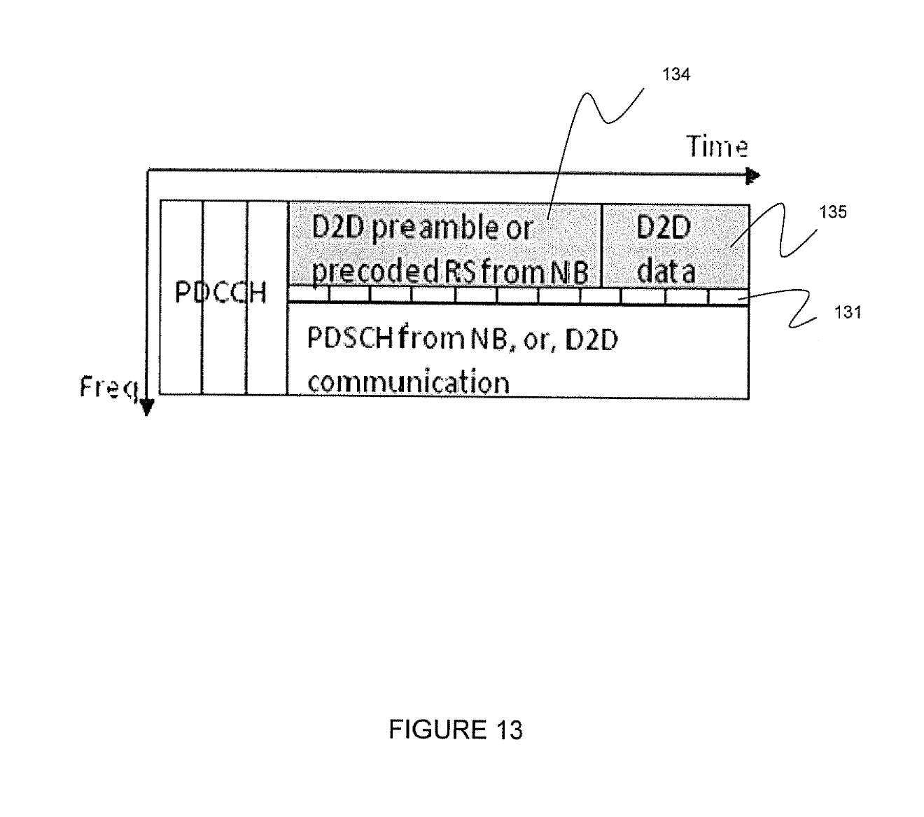

A third method embodiment is depicted in FIG. 13. In this method, some frequency resources are reserved in some PDSCH symbols in a downlink frame for either D2D preamble transmission, or Node B beamform/precoded matrix transmission. In this approach, no cellular UE transmission is scheduled in the reserved frequency portions of certain symbols in the DL subframe. When the subframe is reserved for D2D preamble transmission, there may be a guard band such as 131 in FIG. 13 between the frequency for the preamble transmission and the frequency for PDSCH symbols. Using this frequency guard band will help to avoid emission interference from NB station transmissions in adjacent physical resource blocks (PRBs). In this approach, as shown in FIG. 13, the D2D preamble does not necessarily require all of the 14-N OFDM symbols in the subframe, the remaining OFDM symbols are then available for D2D communication such as 133 in FIG. 13.

In order to implement any of the method embodiments described above for interference measurement and reporting in a cellular system with D2D devices, there should be some coordination between cells. This is accomplished by level 1 signaling or higher layer signaling to coordinate the reserved resources between eNBs. To provide flexible resource reservation, there can be parameters for resource length in both the time and the frequency domains.

The second and third embodiments, described above, both reserve resources in PDSCH or PDCCH communications. These embodiments are applicable to both FDD and TDD cellular systems. In LTE-A systems, with carrier aggregation (CA), due to the possibility of cross-cc scheduling, there can be some PDCCH-less carriers. The method may then be implemented in these PDCCH-less carriers.

For sending the D2D preamble transmission to the NB station, the D2D UEs can be frequency division multiplexed (FDM), or time division multiplexed (TDM) or both. The cellular UEs may report interference for each D2D device, or only from the strongest received interference. The reports are transmitted from a UE or device to the node-B using a portion of an allocated UL resource.

The communication spectral efficiency is improved by these methods which provide an approach efficiently reusing a communication resource by user equipment participating in D2D communications. The interference measurements may be used by the cell serving NB to allocate resources in DL sub-frames for use by D2D devices in a manner that will minimize interference between the D2D devices and cellular devices. The allocation of the resources may be performed so that the use of D2D communications in the cellular system is supported without impacting the efficiency of cellular communications, and because D2D messages do not require the participation of the NB station, the resource usage efficiency may be increased overall. The process described hereinabove, using portions of DL resources for measuring interference using wireless communication devices such as user equipment communicating with an access point such as a base station, may be readily extended to other spectrum reuse cases, thereby providing a generic solution for secondary communication spectrum usage.

Thus, an apparatus, method and system are introduced herein for efficiently performing interference transmissions and measurements and reporting the measurements for controlling direct device-to-device communications in a communication system. In one embodiment, an apparatus (e.g., embodied in a user equipment) includes a processor and memory including computer program code. The memory and the computer program code are configured, with the processor, to cause the apparatus to monitor an interference transmission and record a measurement from a base station to a user equipment participating in cellular communications employing a communication resource, and allocate downlink resources for D2D communications employing the communication resource as a function of the interference measurements, thereby reducing interference with the cellular communications.

Additionally, the memory and the computer program code are further configured, with the processor, to cause the apparatus to allocate D2D resources in the DL resources when beamforming is used by the node B to create spatial resource reuse of the spectrum. The memory and the computer program code are further configured, with the processor, to cause the apparatus to allocate portions of PDCCH messages in the DL resource for use by D2D devices to transmit preambles that enable interference measurements. The memory and the computer program code are further configured, with the processor, to cause the apparatus to monitor a measurement report received from a cellular UE that detected the preamble transmission of a D2D device in a downlink communications resource. Although the apparatus, methods and system described herein have been described with respect to cellular-based communication systems, the apparatus and method are equally applicable to other types of communication systems such as a WiMax® communication system.

Program or code segments making up the various embodiments of the present invention may be stored in a computer readable medium or transmitted by a computer data signal embodied in a carrier wave, or a signal modulated by a carrier, over a transmission medium. For instance, a computer program product including a program code stored in a computer readable medium may form various embodiments of the present invention. The “computer readable medium” may include any medium that can store or transfer information. Examples of the computer readable medium include an electronic circuit, a semiconductor memory device, a read only memory (“ROM”), a flash memory, an erasable ROM (“EROM”), a floppy diskette, a compact disk (“CD”)-ROM, an optical disk, a hard disk, a fiber optic medium, a radio frequency (“RF”) link, and the like. The computer data signal may include any signal that can propagate over a transmission medium such as electronic communication network communication channels, optical fibers, air, electromagnetic links, RF links, and the like. The code segments may be downloaded via computer networks such as the Internet, Intranet, and the like.

As described above, the exemplary embodiments provide both methods and corresponding apparatus consisting of various modules providing functionality for performing the steps of the methods. The modules may be implemented as hardware (embodied in one or more chips including an integrated circuit such as an application specific integrated circuit), or may be implemented as software or firmware for execution by a computer processor. In particular, in the case of firmware or software, the exemplary embodiment can be provided as a computer program product including a computer readable storage structure embodying computer program code (i.e., software or firmware) thereon for execution by the computer processor.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof. Also, many of the features, functions and steps of operating the same may be reordered, omitted, added, etc., and still fall within the broad scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1-27. (canceled)

28. An apparatus, comprising:
a processor; and
memory including computer program code,
said memory and said computer program code configured, with said processor, to cause said apparatus to perform at least the following:
receive a downlink (DL) resource allocation reserving a portion of symbols for a device-to-device (D2D) preamble transmission;
monitor an interference transmission from D2D user equipment participating in cellular communications employing a communication resource; and
format a message for reporting the interference levels observed during the interference transmission.

29. The apparatus as in claim 28 wherein said memory and said computer program code are further configured, with said processor, to cause said apparatus to transmit the message for reporting over the communications resource.

30. The apparatus as in claim 28 wherein said memory and said computer program code are further configured, with said processor, to cause said apparatus to monitor the interference transmission over the communications resource during a guard period (GP) in a special signaling subframe.

31. The apparatus as in claim 28 wherein said memory and said computer program code are further configured, with said processor, to cause said apparatus to monitor the interference transmission during a physical downlink control channel communication.

32. The apparatus as in claim 31 wherein said memory and said computer program code are further configured, with said processor, to cause said apparatus to monitor the interference transmission during a predetermined portion of a symbol period of a physical downlink control channel message.

33. The apparatus as in claim 28 wherein said memory and said computer program code are further configured, with said processor, to cause said apparatus to monitor the interference transmission during a physical downlink shared control channel on the communications resource.

34. The apparatus as in claim 28 wherein said memory and said computer program code are further configured, with said processor, to cause said apparatus to generate a report to be formatted as an interference measurement result based on the received signal power in the monitored resource for transmission to a base station on the communications resource.

35. The apparatus as in claim 28 wherein said memory and said computer program code are further configured, with said processor, to cause said apparatus to generate a report to be formatted as an interference measurement result based on the received signal power in one selected from the group consisting essentially of the guard period, the physical downlink control channel and the physical downlink shared channel for transmission to a base station on the communications resource.

36. An apparatus, comprising:
a processor; and
memory including computer program code,
said memory and said computer program code configured, with said processor, to cause said apparatus to perform at least the following:
receive a resource allocation for a device-to-device (D2D) preamble message to be sent enabling an interference measurement during a specified symbol period in a time division duplex (TDD) frame on a communications resource in a cellular communications system; and
format a D2D preamble for communications during the specified symbol on the TDD frame in the communications resource.

37. The apparatus of claim 36, wherein said memory and said computer program code are further configured, with said processor, to cause said apparatus to transmit a D2D preamble during the specified symbol on the communications resource.

38. The apparatus of claim 36, wherein said memory and said computer program code are further configured, with said processor, to cause said apparatus to format a D2D preamble for a guard period of a special subframe during the TDD frame on the communications resource.

39. The apparatus of claim 36, wherein said memory and said computer program code are further configured, with said processor, to cause said apparatus to format a D2D preamble for at least one symbol of a physical downlink control channel (PDCCH) during the TDD frame on the communications resource.

40. The apparatus of claim 36, wherein said memory and said computer program code are further configured, with said processor, to cause said apparatus to format a D2D preamble for at least one symbol of a physical downlink shared channel (PDSCH) during the TDD frame on the communications resource.

41. A method, comprising:
receiving a resource allocation for a downlink resource in a communications resource in a cellular system reserving predefined symbols for a device to device (D2D) preamble transmission enabling an interference measurement; and
monitoring the device-to-device (D2D) preamble employing said downlink resource in said communication resource as a function of the received resource allocation.

42. The method as in claim 41 further comprising formatting a report recording the strongest D2D preamble received during the downlink resource.

43. The method as in claim 42 further comprising transmitting the report to a base station in the communications resource.

44. The method as in claim 41 further comprising formatting a report recording all of the D2D preambles received during the downlink resource in the communications resource.

45. An apparatus, comprising:
a processor; and
memory including computer program code,
said memory and said computer program code configured, with said processor, to cause said apparatus to perform at least the following:
receive a resource allocation for a downlink resource in a communications resource in a cellular system reserving one selected from beamforming symbols and predefined precoded reference symbols (RS) for a transmission enabling an interference measurement; and
monitor the beamforming symbols or RS employing said downlink resource in said communication resource as a function of the received resource allocation.

46. The apparatus of claim 45 wherein the memory and the computer program code are also configured to, with the processor, cause the apparatus to perform at least the following:
format a report recording the strongest beamforming symbols or RS received during the downlink resource.

47. The apparatus of claim 46 wherein the memory and the computer program code are also configured to, with the processor, cause the apparatus to perform at least the following:
transmit the report to a base station using the communications resource.
